(19) United States
(12) Patent Application Publication
(10) Pub. No.: US 2005/0157507 A1
(43) Pub. Date: Jul. 21, 2005

(54) Desk lamp with microswitch

(76) Inventor: Chun-I Chen, Taichung (TW)

Correspondence Address: Wisam Enterprises Co., Ltd., P. O. Box No. 6-57, Junghe, Taipei, 235, TW

(21) Appl. No.: 10/759,040

(22) Filed: Jan. 20, 2004

(51) Int. Cl. F21V 23/04

(52) U.S. Cl. 362/395; 362/410

(57) ABSTRACT

A desk lamp with microswitch, characterized in that a sphere is configured on the base utilizing a flexible tube to mutually connect to the base thereof, and two sphere seats are further defined in the base such that shape of each sphere seat respectively corresponds with shape of the sphere. A microswitch is further configured below one of the sphere seats. According to foresaid, upon the sphere being positioned within the sphere seat having the microswitch configured below thereof, an electrical connection is thereby realized with the power supply, which thus enables the light bulb to shine. Hence, the present invention enhances eye appeal and fascination of the desk lamp, as well as achieving efficacy of endowing a consumer with a novel feeling toward the desk lamp and thus producing a desire to purchase the desk lamp.

### BACKGROUND OF THE INVENTION

(a) Field of the Invention

The present invention relates to a structure of a desk lamp with microswitch, and more particularly to the desk lamp that enhances eye appeal and fascination, as well as achieving efficacy of endowing a consumer with a novel feeling toward the desk lamp and thus producing a desire to purchase the desk lamp.

(b) Description of the Prior Art

Accordingly, a switch used by a conventional desk lamp generally relies on employment of external means to control an electric contact for opening or closing of an electric circuit. Common switches in usage include a push button switch, a cutover switch, a knob switch, and so on, albeit having structures which are largely identical with minor differences. Furthermore, different style desk lamps merely differ in alteration of exterior, and a power switch of the desk lamp has never undergone any innovative design changes in applicable usage of such. Hence, because of lack in any characteristic innovation, desire of a consumer to purchase such desk lamps naturally declines considerably, and therefore there is a need for research and development to improve upon the structure of the conventional desk lamp.

### SUMMARY OF THE INVENTION

In light of aforementioned shortcomings of a conventional desk lamp, the inventor of the present invention, having accumulated years of professional experience engaged in related art, has undertaken attentive and circumspect research to finally design a completely new desk lamp with microswitch.

A primary objective of the present invention is to provide the desk lamp that enhances fascination in usage, as well as achieving efficacy of endowing a consumer with a novel feeling toward the desk lamp and thus producing a desire to purchase the desk lamp.

To achieve aforesaid objective, the desk lamp with microswitch of the present invention primarily comprises a configuration having functionality to turn on and turn off configured in a base of the desk lamp, and characterized in that a sphere is configured on the base utilizing a flexible tube to mutually connect to the base thereof, and two sphere seats are further defined in the base such that shape of each sphere seat respectively corresponds with shape of the sphere. A microswitch is further configured below one of the sphere seats, and the microswitch is so connected to enable a power supply and a light bulb to form a circuit loop therefrom.

According to the aforementioned, upon the sphere being positioned within the sphere seat having the microswitch configured below thereof, an electrical connection is thereby realized with the power supply, which thus enables the light bulb to shine. When the sphere is moved away to the other sphere seat, the microswitch thereupon cuts off the power supply, and hence turns off the light bulb. Hence, the present invention enhances fascination of the desk lamp, as well as achieving efficacy of endowing a consumer with a novel feeling toward the desk lamp and thus producing a desire to purchase the desk lamp.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational cutaway view according to the present invention.

FIG. 2 shows a schematic view of a desk lamp in usage according to the present invention.

FIG. 3 shows a schematic view of a microswitch not yet activated according to the present invention.

FIG. 4 shows a cross sectional schematic view of the microswitch activated according to the present invention.

FIG. 5 shows an elevational cutaway view of another embodiment according to the present invention.

### DETAILED DESCRIPTION OF THE PREFERRED EMBODIMENTS

Structure, installation and characteristics of preferred, feasible embodiments of the present invention are disclosed in the following detailed description in conjunction with accompanying drawings:

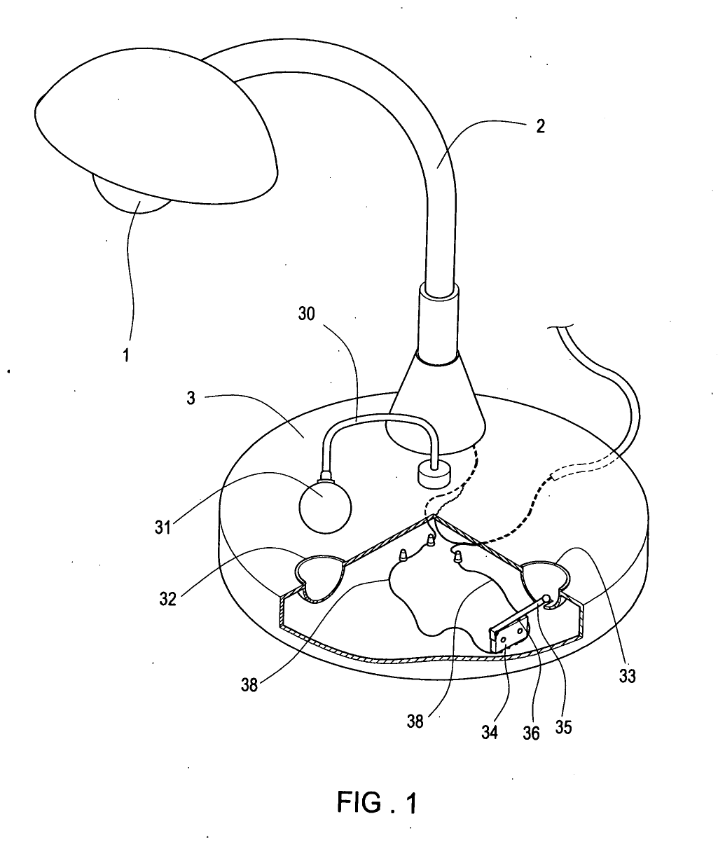

Referring to FIG. 1, which shows a structure of a desk lamp with microswitch according to the present invention, having a primary structure comprising a light bulb 1, a support stand 2, and a base 3, and characterized in that:

A sphere 31 is configured on the base 3 utilizing a flexible tube 30 to mutually connect to the base 3 thereof. A general sphere seat 32 and a sensor sphere seat 33 are further defined in the base 3 such that shape of each respectively corresponds with shape of the sphere 31. A microswitch 34 is further configured below the sensor sphere seat 33, and the microswitch 34 is connected to a power cord 38, thereby enabling the power supply and the light bulb 1 to form a circuit loop therefrom.

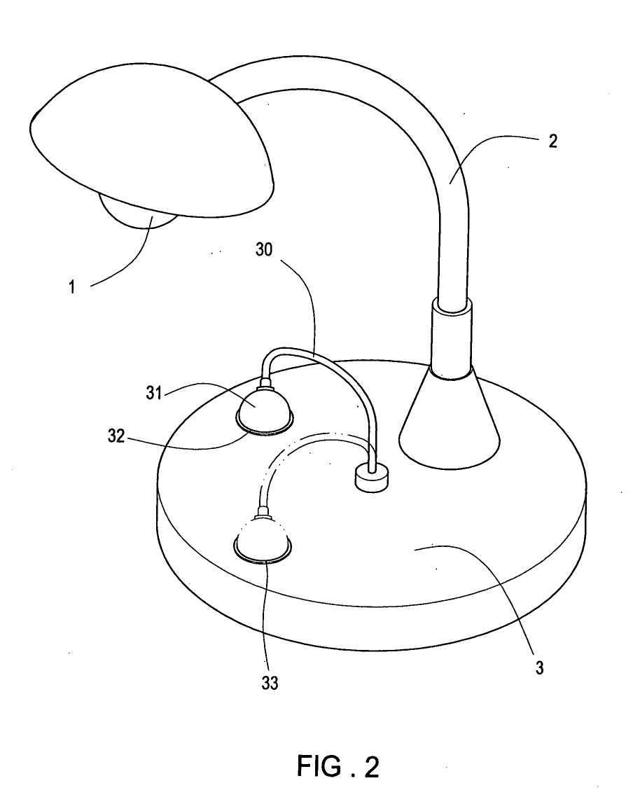

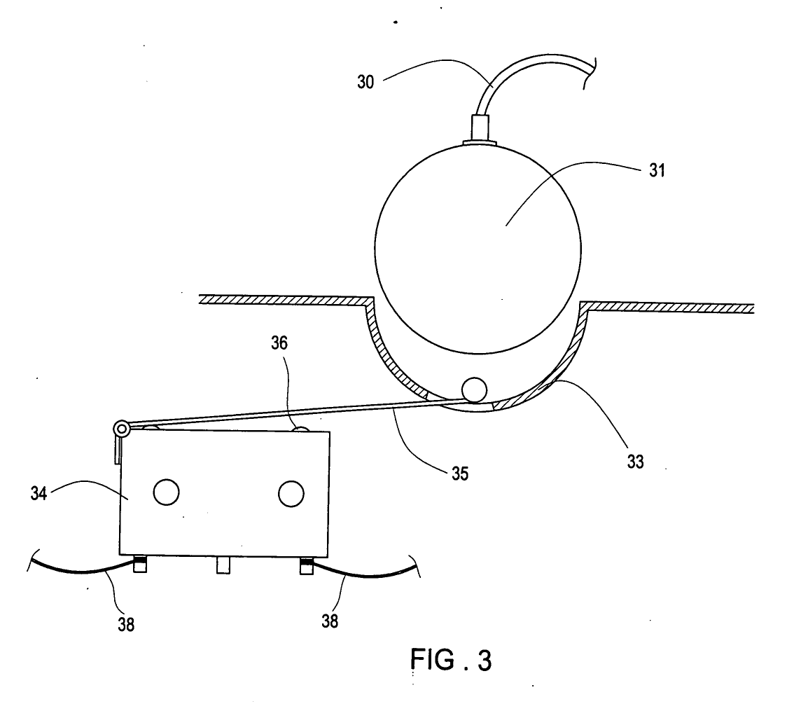

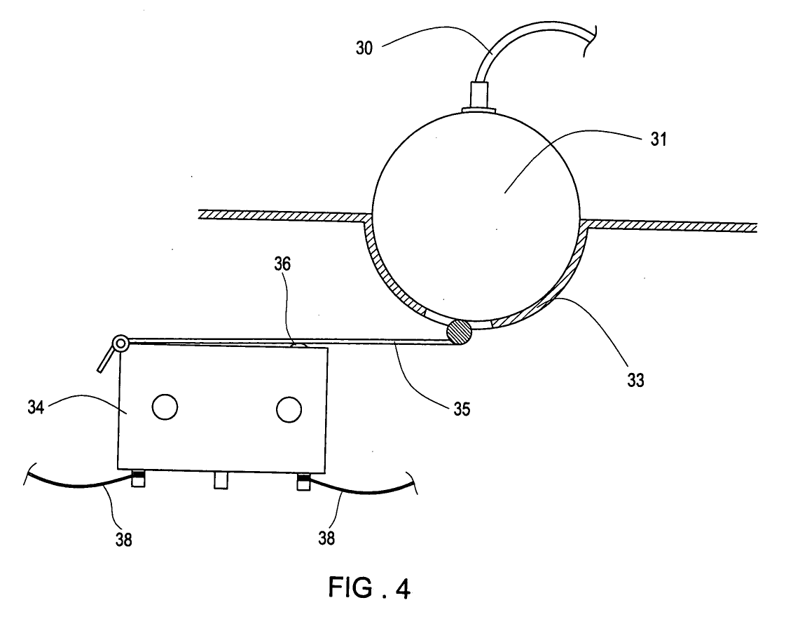

According to aforementioned structure, and referring to FIGS. 2, 3 and 4, a rocking arm 35 and a sensor point 36 are configured on the microswitch 34 thereof. One end of the rocking arm 35 protrudes slightly from a bottom of the sensor sphere seat 33, and the sensor point 36 is located below the rocking arm 35. Upon the sphere 31 being positioned within the sensor sphere seat 33, weight of the sphere 31 presses down the rocking arm 35, and the rocking arm 35 thereupon presses down on the sensor point 36, which thus realizes an electrical connection with a power supply contact interior to the microswitch, and flow of electricity thereof, thereby enabling the light bulb 1 to shine. After the sphere 31 moves away from the sensor sphere seat 33, the rocking arm 35 and the sensor point 36 automatically return to respective original positions, thereby enabling the power supply contact interior to the microswitch 34 to resume status of an open circuit, and thus turning off the light bulb 1. Furthermore, after the sphere 31 has moved away from the sensor sphere seat 33, the sphere 31 is positioned in the general sphere seat 32, thus prohibiting the sphere 31 from freely rolling around.

In respect of foresaid, the structure of the desk lamp with microswitch according to the present invention differs greatly in comparison to configuration of a conventional desk lamp switch and mode of usage. The structure of the microswitch structure for a desk lamp according to the present invention bestows the desk lamp with fascination, and averts feeling of a bulginess resulting from a conventional switch configured atop the desk lamp thereof.

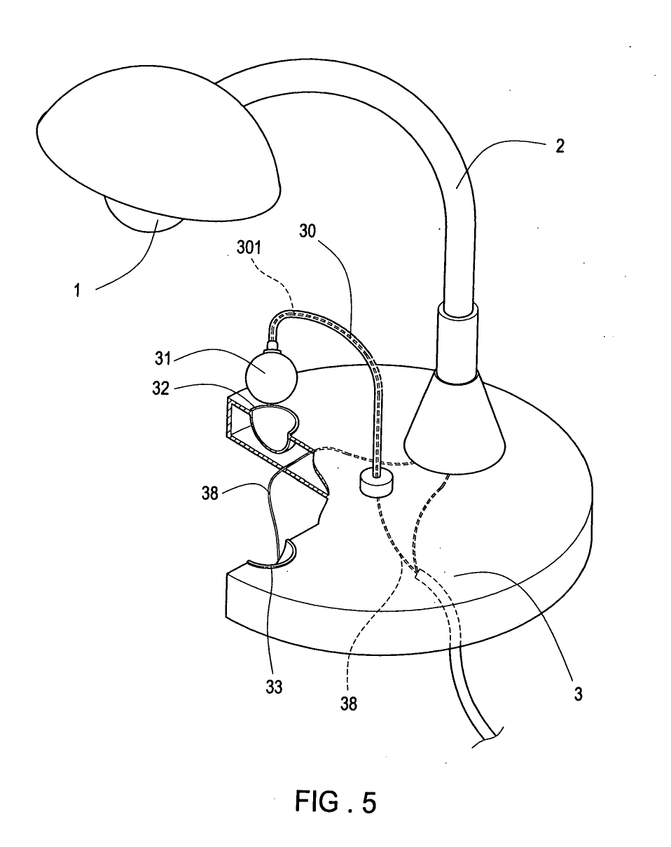

Furthermore, referring to FIG. 5, which shows another embodiment according to the present invention embracing a low voltage control design. The sphere 31 and the sensor sphere seat 33 are fabricated from metallic conducting material, and a conducting wire 301 is configured within the flexible tube 30. Moreover, the conducting wire 301, the sphere 31, the sensor sphere seat 33 and the power cord 38 are mutually connected. Thus, upon the sphere 31 being positioned in the sensor sphere seat 33, an electric current flowing in the power cord 38 thereby forms an electric circuit by means of the flexible tube 30, the sphere 31 and the sensor sphere seat 33, and accordingly the electric current flows into the light bulb 1 thereby allowing the light bulb to shine:

In conclusion, the desk lamp with microswitch of the present invention assuredly enhances eye appeal and fascination of the desk lamp, as well as achieving efficacy of endowing a consumer with a novel feeling toward the desk lamp and thus producing a desire to purchase the desk lamp. The present invention is further provided with practicability and advancement. Accordingly, the inventor of the present invention hereby proposes an application for a new patent as disclosed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A desk lamp with microswitch, having a primary structure comprising a light bulb, a support stand, and a base, and characterized in that: a sphere is configured on the base utilizing a flexible tube to mutually connect to the base thereof, and a general sphere seat and a sensor sphere seat are further defined in the base such that shape of each sphere seat respectively corresponds with shape of the sphere; a microswitch is further configured below the sensor sphere seat, and the microswitch is connected to a power cord, accordingly, a power supply and a light bulb are so configured to constitute a circuit loop.

2. A desk lamp with microswitch according to clam 1, wherein the sphere and the sensor sphere seat are fabricated from metallic conducting material, and a conducting wire is configured within the flexible tube, moreover, the conducting wire, the sphere, the sensor sphere seat and the power cord are mutually connected.
